(19) United States
(12) Patent Application Publication
(10) Pub. No.: US 2007/0162390 A1
(43) Pub. Date: Jul. 12, 2007

(54) Techniques for distributing and monitoring content

(75) Inventors: Mitesh Pancholy, San Francisco, CA (US); Alexander James Gow, Berkshire (GB)

Correspondence Address: SCHWEGMAN, LUNDBERG, WOESSNER & KLUTH, P.A., P.O. BOX 2938, MINNEAPOLIS, MN, 55402, US

(73) Assignee: Macrovision Corporation

(21) Appl. No.: 11/316,717

(22) Filed: Dec. 22, 2005

(51) Int. Cl. G06Q 99/00

(52) U.S. Cl. 705/50

(57) ABSTRACT

Techniques for distributing and monitoring content are provided. Identifiers are separated from content embedded on content media. When content media is interfaced to a machine, the associated identifier is acquired. The identifier is submitted to an authentication service for authentication. If successful authentication occurs, an access key is supplied to the machine and the action requested on the machine is taken with respect to the content.

### FIELD

The invention relates generally to content management and more specifically to distributing and monitoring content.

### BACKGROUND

Pirated content is a growing problem for content owners. Piracy is particularly problematic in the highly wired environment of the Internet. Content illegally copied and transmitted over the Internet has the potential to become pervasively available all over the world in a matter of minutes. The thought of this can keep content owners awake at night and it is also what drives content owners to continually attempt to develop techniques to thwart electronic piracy.

Generally techniques for protecting electronic content rely on keys or codes embedded with that content. One obvious problem with these techniques is that if the keys are intercepted, then they can be used to illegally unlock the content. The key may permit encrypted content to be unlocked or decrypted. In other cases, the key may be viewed as a license (or may identify a location of a license), which needs to be present in order for a media player to play the content.

Another issue is that content distributed on tangible media, such as Compact Disks (CD's), Digital Versatile Disks (DVD's), etc., can be copied by recording devices to memory, storage, or other removable media. In some cases, if the entire media is copied then the key is also copied, such that it becomes very difficult to distinguish between the original media or the copied media. What makes things more problematic is that often existing copyright laws permit a licensee to make backup copies of purchased content for personal use. So, preventing a copy may not be practical or even lawful. The problem lies in how to tell if more than a single backup copy is created by a licensee, since a single copy may be permissible but a second copy beyond the single backup copy is not.

As a result, more unscrupulous licensees may make large volumes of copies on removable media and then unlawfully sell the copies are substantially lower prices then the content owner. Such a situation is particularly problematic in foreign countries where the enforcement of intellectual property (IP) laws is lax or non existent, such that an IP pirate generally does not fear repercussions from the government and acts with capitalist abandon. It is apparent that the very technology that expanded the reach of content has now made the protection of that content more problematic and challenging for content owners.

Accordingly, improved techniques for distributing and monitoring content are needed.

### SUMMARY

In various embodiments, techniques for distributing and monitoring content are presented. More specifically, and in an embodiment, a content distribution and monitoring system is provided. The content distribution and monitoring system includes content media and an authentication service. The content media includes an identifier separated from content; the content identifier residing on the media and uniquely identifies the content and the content media. The content identifier is acquired when the content media is interfaced to a machine and it is supplied to the authentication service. The authentication service authenticates the identifier and supplies an access key to the machine for playing the content, if authentication is successful.

### BRIEF DESCRIPTION OF THE DRAWINGS

FIG. 1 is a diagram of a content distribution and monitoring system, according to an example embodiment.

FIG. 2 is a diagram of a method for distributing and monitoring content, according to an example embodiment.

FIG. 3 is a diagram of another method for distributing and monitoring content, according to an example embodiment.

### DETAILED DESCRIPTION

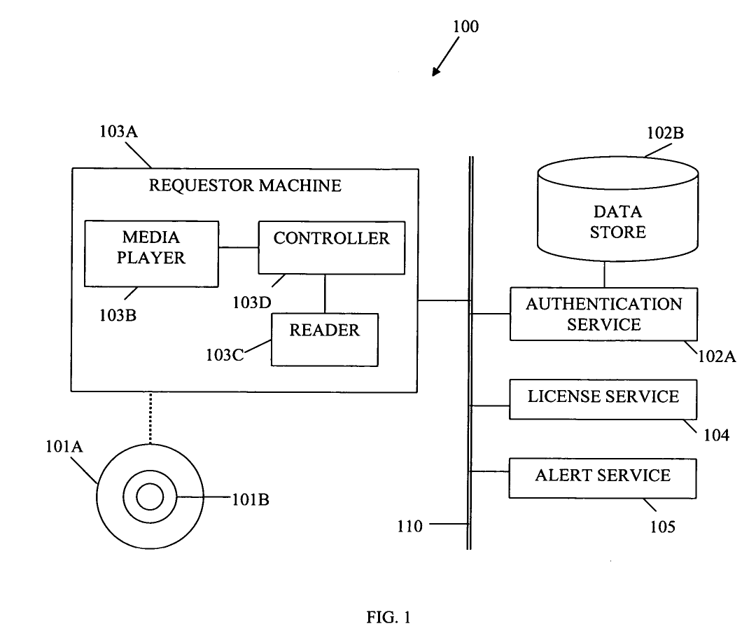

FIG. 1 is a diagram of a content distribution and monitoring system 100, according to an example embodiment. The distribution and monitoring system 100 is implemented in a machine accessible and readable medium and is accessible over a network 110. The network 110 may be wired, wireless, or a combination of wired and wireless.

As will be demonstrated in the discussion that follows, the distribution and monitoring system 100 permits content and media associated with that content to be uniquely identified, distributed, and monitored. This is achieved by supplying identifiers with the media that is separated from the content and processing the identifiers to authenticate the content or media and to enforce licensing restrictions.

The distribution and monitoring system 100 includes a content media 101A-101B and an authentication service 102A. The distribution and monitoring system 100 may also include a data store 102B, a media player 103B (residing on a requestor machine 103A), a reader 103C, a controller 103D, a license service 104, and/or an alert service 105. Each of these will now be discussed in turn.

The content media 101A may be a CD, DVD, memory stick, Universal Serial Bus (USB) Key, Dongle, etc. The content media 101A includes or provides access to content. Content may be any electronic media whose distribution and use is subject to controls or licenses, such as but not limited to software programs, movies, music, presentations, literary works, and others.

Each content media 101A includes an identifier. The identifier may be activated from within the content media 101A by processing a chip embedded on the content media 101A. Alternatively, the identifier may be affixed on the outside surface of the content media 101A or content media packaging as a Radio Frequency Identification (RFI) tag or bar code. The identifier uniquely identifies the content and the content media 101A. In a sense, the identifier may be viewed as a serial number for the content and the content media 101A in a manner that traditionally exists for hardware devices, only in this case the serial number is for a specific instance of the content on a specific content media 101A or its packaging.

According to an embodiment, the content media 101A is a CD or DVD that includes an unused inner ring portion 101B that does not include content. The inner ring portion 101B traditionally would not house any electronic information. The identifier is activated from this inner ring portion 101B of the content media 101A. For example, a chip may be embedded within the inner ring portion 101B and a CD or DVD reader 103C may be designed to provide energy to process the chip. When the chip is processed, the chip writes the identifier to a memory or storage location within a requestor's machine 103A. In another embodiment, the inner ring portion 101B includes an RFID tag and an RFID reader 103C is designed to read the tag and supply the identifier for the content media

In an embodiment, the content media 101A may be mass produced without any content and may include a chip and/or RFID tag to uniquely identify each content media 101A. The chip or RFID tag embedded or affixed to the inner ring portion 101B of the content media 101A. A data store or list may be supplied to a content owner that then presses content onto the content media 101A and associates each piece of content to a specific identifier using the data store or list. Similarly, the content may be embedded within the content media 101A and then subsequently a chip or RFID tag may be added to each instance of the content media 101A and associated therewith.

In still another embodiment, the inner portion 101B of the content media 101A may include a label for a bar code, such that a bar code reader 103C may be used to acquire the identifier for the content media 101A. In fact, a variety of modifications to readers 103C or types of identifiers may be associated with the content media 101A in such a manner that the identifier is not directly embedded with the content that also resides on the content media 101A and in such a manner that the reader 103C can acquire the identifier. Also, any labels used may be written directly onto the surface of the content media or may be affixed to the surface, such as by means of an adhesive associated with a paper label.

Once the identifier is acquired from the content media 101A from a requestor machine 103A it is supplied over a network 110 to an authentication service 102A. The authentication service 102A uses the identifier and perhaps the identity of a requestor to authenticate the content residing on the content media 101A for use by the requestor on the requestor machine 103A.

According to an embodiment, the identifier acquired from the content media 101A from a reader 103C on the requestor machine 103A may be encrypted and sent securely or insecurely over the network 110 to the authentication service 102A. That is, the communication over the network 110 may be secure, such as via Secure Sockets Layer (SSL), or may be insecure, such as via Hypertext Transfer Protocol (HTTP) when the encryption is used. In other cases, the identifier may be unencrypted and sent of the network 110, in such a case it may be beneficial to use a secure communication channel, rather than an insecure channel over the network 110.

The authentication service 102A once it acquires the identifier may use a data store 102B to lookup the identifier. Moreover, if the identifier was encrypted it may be decrypted by the authentication service 102A. The data store 102B permits the authentication service 102A to acquire a policy or identify a license service 104 for the identifier. The policy may identifier a specific requestor, specific licensing restrictions, and the like. The policy may be viewed as a set of business rules that is specifically associated with a given identifier or is associated with a group of given identifiers that are locally associated with one another.

The data store 102B may be a relational database, a collection of databases organized as a data warehouse, a directory, or various combinations of the same.

It is also to be understood that the authentication service 102A may manage its own rules and/or policies with respect to a given identifier and does not have to enlist a data store 102B to facilitate that management; although as illustrated above this can be the case in some embodiments.

Additionally, the authentication service 102A may enlist one or more external licensing services 104 to acquire business rules or policies for a given identifier. For example, the authentication service 102A may be a generic service that is contacted with identifiers. The identifiers may include partial information that identifies a specific content owner and the identity of that content owner allows the authentication service 102A to contact a specific licensing service 104 that then supplies business rules or policies or evaluates the rules and policies on behalf of the authentication service 102A.

The authentication service 102A may also be used to gather and track metrics associated with a given identifier or with a class or group of identifiers. These metrics may be stored in the data store 102B and subsequently used to generate reports or raise alarms. The reports and alarms may also be driven by other policies specific to content owners or groupings of identifiers.

According to an embodiment, the distribution and monitoring system 100 may also include an alert service 105. The authentication service 102A may directly interface with the alert service 105 or the alert service 105 may have access to any data store 102B where metrics and/or audit trails are being generated by the authentication service 102A. The alert service 105 may be used to notify content owners or automated services identified by content owners when predefined events or thresholds are detected with respect to a specific identifier or a class of identifiers.

For example, a content owner may be notified via the alert service 105 when a requestor submits an identifier that is invalid or that should not be associated with that particular requestor. In another example, the alert service 105 may notify a content owner when a specific identifier appears that it is being used outside the scope of a license or is approaching a licensing threshold. The content owner may use the information to suggest a renewal or upgrade to a specific requestor or to warn that requestor. In fact, the alert service 105 may be used for a variety of beneficial purposes that can be configured based on policy independent of the authentication service 102A or in cooperation with the authentication service 102A. The reports may be to content owners or to automated services identified by the content owners.

It should also be noted, that the alert service 105 may be used to report or send notifications for having specific data and metrics, such as requestor R attempted to burn the content to a new content media. Additionally, the alert service 105 may be used to aggregate and report general metrics, such as during a given time period N number of requestors played the content and played it at these times and on these days.

The authentication service 102A may either determine on its own or through the assistance of any licensing service 104 that an identifier for a given requestor is valid or invalid. If invalid a notice may be sent back to the requestor machine 103A that prevents the content embedded in the content media 101A from being accessed or used on the requestor machine 103A.

If the identification is authenticated, then the authentication service may return an access key to the requestor machine 103A. The access key may itself include certain strictures that are enforced within the environment of the requestor machine 103A. For example, the access key may permit the content to be copied off the content media 101A into storage or memory of the requestor machine 103A or to another and different content media 101A. In another example, the access key may permit the content to be played or executed within the environment of the requestor machine 103A but may have some expiration date or time associated with it. Thus, in some cases, the access key may be more intelligent and include rules that are enforced on the requestor machine 103A. In other cases, the access key provides unfettered access for whatever period that the access key remains valid.

The access key may be used for more than just playing the content. That is, any action that the requestor machine 103A may take may use the access key. For example, the content residing on the content media 101A may be associated with actions such as stopping, pausing, recording, rewinding, fast forwarding, and the like. Each action may itself be the subject of an access key. In this manner, the content may pursuant to licensing use an access key for performing any action against that media and the action does not have to be exclusively associated with just playing the content.

The distribution and monitoring system 100 may also include a variety of components that reside within the requestor machine 103A that help facilitate the communications of the distribution and monitoring system 100. For example, and as was discussed above, a reader 103C may be used to acquire the identifier off the content media 101A. The reader 103C may be modified to detect a variety of events that a nefarious requestor may use in an attempt to defeat the teachings presented herein. For example, a requestor may stack media together, such that one media is used to authenticate another media for use. To thwart this, the reader 103C may record the velocity used for acquiring the identifier off the valid content media 101A and check to see if to identification tags are spinning at the same velocities and have an approximate threshold distance separating the tags that is less than the thickness of the two disks (media stacked).

The requestor machine 101A may also include a controller 103D that is designed to acquire the identification from the reader 103C or from a memory or storage location, if a chip processed on the content media 101A to obtain the identifier. The controller 103D then interacts over the network 110 with the authentication service 102A and acquires the access key.

The controller 103D then provides the access key to a media player 103B or to the content uploaded off the content media 101A. For example, if the content is a movie or audio, then a media player 103B may require the access key from the controller 103D or from a defined file or location before the movie or audio may be played on the requestor machine 103A.

In another example, if the content is an executable program, then the program may require the access key before it processes its instructions. In some cases, the program may at least partially process a subset of its instructions or services without the access key, but may keep certain instructions or services locked until a valid access key is supplied. In this manner, some content media 101A may be distributed for free and may be renewed or have value added services activated by means of the access key.

In still another embodiment, the requestor machine 103A may be equipped with a Global Positioning Satellite (GPS) receiver, such that the geographic position of the requestor machine 103A may be determined at any particular point in time. The controller 103D supplies the geographic GPS coordinate for the requestor machine 103A along with an identifier obtained from the content media 101A. Rules or policies acquired from the authentication service 102A then enforce whether the access key is supplied based on the GPS coordinate. This may be particularly useful for the military or for corporate intelligence, where the content residing on the content media 101A is to be used only at a given geographic position or within a given geographic range. Thus, if an enemy acquired the content media 101A it would prove useless to them and the authentication service 102A may even be able to tell where it is located if the enemy had a GPS enabled machine, if not the authentication service 102A may at least be able to report the attempted use of the content.

In a variation of the previous embodiment, the authentication service 102A may be able to derive or estimate a location of the requestor machine 103A my means of an Internet Protocol (IP) address or Internet domain that is associated with the requestor machine 103A or an email address of the requestor. The estimated location can be used to enforce location specific or domain specific restrictions before the access key is supplied by the authentication service 102A.

It is now understood how a distribution and monitoring system 100 may be implemented to better distribute and monitor content. Content media 101A that includes content includes identifiers separated from the embedded content. The identifiers are supplied over a network 110 to an authentication service 102A. The authentication service 102A enforces rules or policies to determine if an access key is granted to a requestor. The access key may be used to play, process, or copy the content and can itself include restrictions. During the process metrics may be gathered and alerts may be raised to further enhance the monitoring and controlling of the content.

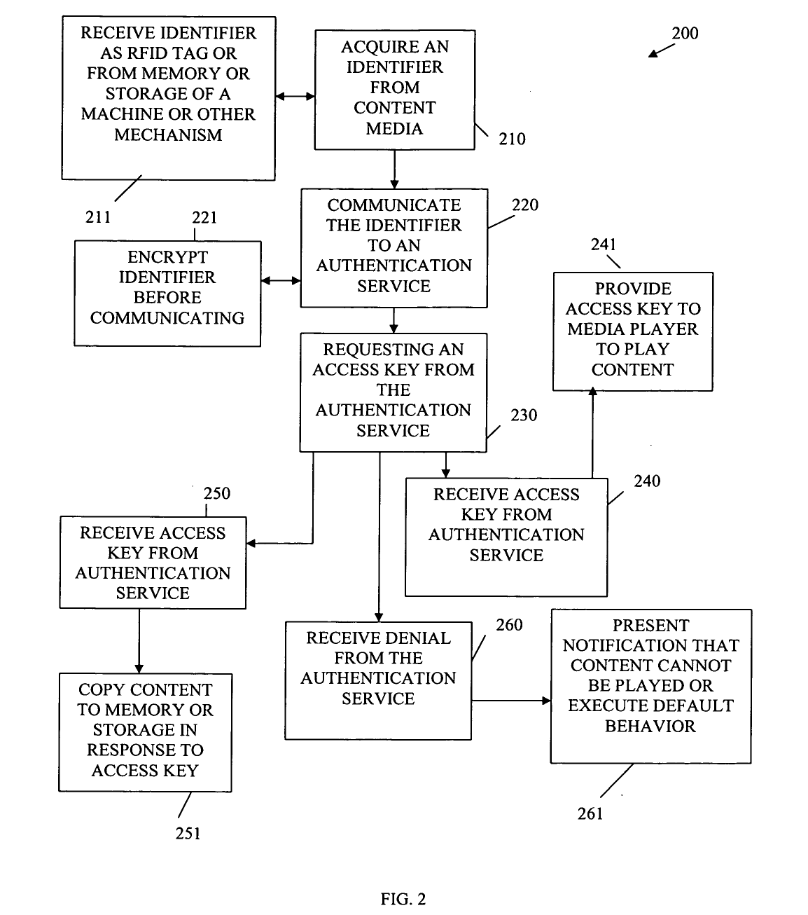

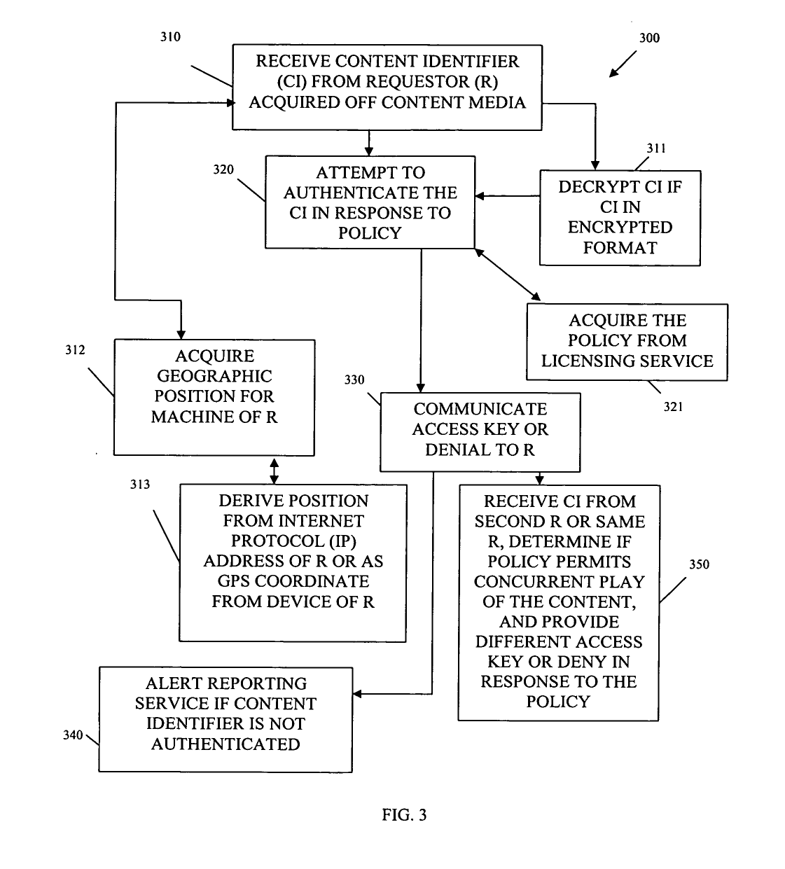

FIG. 2 is a diagram of a method 200 for distributing and monitoring content, according to an example embodiment. The method 200 (hereinafter “requestor content service”) is implemented in a machine-accessible and readable medium and is accessible over a network. The network may be wired, wireless, or a combination of wired and wireless. The processing of the requestor content service represents processing of the content distribution and monitoring system 100 that occurs within the environment of the requestor machine 103A. The processing, which is external to the requestor machine 103A is depicted and described below with respect to the method 300 of FIG. 3.

The requestor content service is implemented as instructions on machine accessible media. The media may be removable, such that when it is interfaced and uploaded to a machine and processed by the machine it performs the processing depicted in FIG. 2. Alternatively, the instructions may be prefabricated within memory or storage of the machine. Still further, the instructions may be downloaded over a network from a different machine or storage device to a processing machine for execution.

At 210, the requestor content service acquires an identifier from a piece of content media interfaced to a requestor's machine. According to an embodiment, at 211, the identifier may be acquired as a RFID tag or from memory or storage of the machine. In still another embodiment, the identifier may be acquired as a barcode from the content media. The identifier is not integrated within the content media within the stream of content that also resides on the content media. That is, the identifier is either activated from a label affixed to or printed on the surface of the content media or the identifier is activated by a chip that when supplied energy from a media reading device writes the identifier to memory or storage of the machine. Examples of this were provided above with respect to the content distribution and monitoring system 100 of the FIG. 1. It should also be noted that the identifier may be acquired by any mechanism that is used to identify the content media.

At 220, the requestor content service communicates the identifier to an authentication service. In an embodiment, at 221, the identifier may be encrypted before it is communicated to the authentication service. One example encryption may be a public-private key pair technique, where a reader associated with acquiring the identifier encrypts the identifier with a private key of the reader and a public key of the authentication service. The authentication service then uses a public key of the reader and its own private key to decrypt the identifier. It is to be understood that other forms of encryption or use of digital signatures and/or certificates may be used when communicating the identifier to the authentication service. Additionally, in some embodiments, no encryption may be used at all. In these latter embodiments, it may be beneficial to use secure communications to communicate the identifier to the authentication service; although this does not have to always be the case.

At 230, the requestor content service requests an access key from the authentication service. This processing may be implicit with the communication of the identifier, at 220. That is, the processing associated with requesting the access key may be inferred by the authentication service upon receipt of the identifier.

Once the authentication service has the request for the access key, the requestor content service waits to hear back from the authentication service. A variety of responses may be subsequently received from the authentication service.

For example, at 240, the requestor content service may receive an access key from the authentication service and, at 241, provide the access key to a media player that consumes or requires the access key to play content embedded on the content media. In cases where the content is a self-contained executable program, then the requestor content service may provide the access key to the program once it is loaded into memory of the machine or to an installer associated with loading the program. In still other cases, if a program exists and is running on the machine, the access key may be supplied to that program for purposes of acquiring the content that may permit the program to self enhance, extend, or upgrade itself.

In another embodiment, at 250, the requestor content service may receive the access key from the authentication service and, at 251, authorize the copying of the content off the content media to memory or storage of the requestor's machine. This may be used to load and install the content if it is a program as discussed above. Alternatively, this may be used to permit the content to be more efficiently accessed and processed by a different program, such as a media player. Still further, this may be used to permit the content to be copied and burned in duplicate to another piece of content media.

The access key, if received from the authentication service, may also include limitations that are self-enforced by programs that process the content within the requestor's machine. For example, the access key may be valid for an elapsed period of time or may expire on a given calendar date. Additionally, the access key may be valid for only a given requestor or given device of the requestor. The enforcement of rules or policies associated with the access key may be done by the programs that consume the access key or may be done by a controller that interfaces or operates in cooperation with the requestor content service within the environment of the requestor's machine. Thus, a controller may remove an access key from a requestor's storage or memory upon the happening of a predefined event defined by the access key. Alternatively, a programming that requires the access key may interpret the strictures of the access key and determine when that access key is no longer valid for continued use.

Thus, at 260, a denial may be received from the authentication service indicating that the requested action with respect to the content media cannot be permitted. If such a situation occurs, at 261, a variety of actions may be taken, such as notifying the requestor that the content may not be played or such as executing some default behavior in response to the denial. So, even if the requested action is not capable of being performed some default action pursuant to policy may be performed, such as playing a trailer of a movie associated with the content media, and the like.

The requestor content service depicts processing within a requestor's environment where the content is being uploaded from content media for consumption by a requestor. The cooperative external processing of the authentication service that supplies the access key and performs a variety of other beneficial processing is described with the method 300 of the FIG. 3.

FIG. 3 is a diagram of another method 300 for distributing and monitoring content, according to an example embodiment. The method 300 (hereinafter “content authentication service”) is implemented in a machine-accessible and readable medium and is operational over a network. The network may be wired, wireless, or a combination of wired and wireless.

The processing of the content authentication service cooperates with instances of the requestor content service represented by the method 200 of the FIG. 1. Additionally, the processing of the content authentication service may be viewed as the processing associated with the authentication service 102A, the licensing service 104, and/or the alert service 105 of the content distribution and monitoring system 100 of the FIG. 1.

Furthermore, similar to the method 200 the content authentication service may be implemented as instructions that are uploaded, downloaded, or prefabricated within a machine. The instructions process remotely from requestor machines that make requests to access content residing in content media.

At 310, the content authentication service receives a content identifier from a requestor. The content identifier is acquired from a content media. It may be embedded within a chip associated with the media, printed on the surface of the media, or affixed to the surface of the media. The content identifier may be a RFID tag, a scanner label, and/or a written from the media by a chip to memory or storage of the requestor's machine or environment.

In some cases, at 311, the content identifier is received in an encrypted format. Accordingly, the content authentication service may decrypt the encrypted identifier before it is processed.

According to an embodiment, at 312, the content authentication service may also acquire a geographic position for the machine of the requestor with the content identifier that is to be authenticated for the requestor. Examples or this were provided above with the content distribution and monitoring system 100 of the FIG. 1. At 313, the geographic position may be a GPS coordinate for the requestor's machine or it may be estimated and derived based on the machine's IP address or the requestor's Internet domain.

At 320, the content authentication service attempts to authenticate the content identifier in response to a policy or set of rules. The policy or rules may be housed in a data store or may be acquired external to the content authentication service from a specific licensing service 104, as depicted at 321. Authentication may be based on a specific policy for the content identifier, based on policy for a set or class of identifiers for which the content identifier belongs, and/or based on a combination of factors used in combination with the content identifier, such as identity of requestor, geographic location, identity of devices for the requestor, etc.

Once the content authentication service decides whether the content identifier can be authenticated or not authenticated, at 330, the content authentication service communicates either an access key to the requestor or a denial. The requestor may then process any access key in the manners discussed above with respect to the content distribution and monitoring system 100 of the FIG. 1 and the requestor content service represented by the method 200 of the FIG. 2.

According to an embodiment, at 340, the content authentication service may alert a reporting service if the content identifier cannot be authenticated. Specific state or metrics associated with receipt of the content identifier may also be supplied to the reporting service. The reporting service may then notify a content owner or an automated service for further processing or action. Examples of this were discussed above with the alerting service 105 of the content distribution and monitoring system 100 of the FIG. 1.

In an embodiment, at 350, the content authentication service may subsequently receive the same content identifier from a different requestor or the same requestor that originally supplied the content identifier, at 310. A different policy may be evaluated in view of this request and if permissible a different access key provided to the requestor or different requestor, as the case may be. This different access key may permit concurrent access or execution of the content associated with the content identifier.

In cases where the policy does not permit concurrent play or execution of the content, the content authentication service may send a denial to the requestor or different requestor that may be informative as to why there is a denial or non informative. When a denial occurs, the content authentication service may log the transaction or notify an alert service, since this may be an indication that the requestor is attempting to use the content outside the present scope of its license. It may also be an opportunity for the content owner to sell the requestor an enhanced or newer license for the content that may permit concurrent play or execution of the content.

It is also noted that the processing at 350 may be nested or repeated any number of times, since a license may permit N number of concurrent accesses for a piece of content and at some point N+1 access attempts may be reached and a denial issued.

It is now understood how content may be distributed and monitored in a more efficient manner so as to protect the interests in that content as dictated by its licenses or policies. Each instance of a particular piece of content may be tracked and may have its own licensing and yet the techniques presented herein permit efficient monitoring and tracking of those customized licenses and of each piece of that content.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A system, including:
content media; and
an authentication service;
wherein the content media includes an identifier separated from content residing on the media that uniquely identifies the content and the content media, and wherein the identifier is acquired when the content media is interfaced to a machine and supplied to the authentication service, the authentication service is to authenticate the identifier and supply an access key to the machine for playing the content.

2. The system of claim 1 further including, a media player, wherein the media player is to play the content on the machine if the access key is acquired from the authentication service.

3. The system of claim 1 further including, an alert service, wherein the alert service is to alert a reporting service if the authentication service does not authenticate the identifier.

4. The system of claim 1 further including, a license service, wherein the license service communicates with the authentication service to enforce a license associated with the content and the identifier.

5. The system of claim 1 further including, an authentication controller, wherein the authentication controller initially acquires the identifier and encrypts the identifier and transmits the encrypted identifier to the authentication service for authentication.

6. The system of claim 1, wherein the authentication controller receives the access key from the authentication service in an encrypted format and decrypts the access key and supplies the decrypted access key to a media player that uses the access key to play the content on the machine.

7. The system of claim 1, wherein the identifier is embedded in an unused portion of the content media or embedded in a radio frequency identification tag affixed to the content media as a label.

8. A machine accessible medium having instructions thereon, the instructions when accessed by a machine perform the method of, including:
acquiring an identifier from content media;
communicating the identifier to an authentication service; and
requesting an access key from the authentication service.

9. The method of claim 8 further including instructions for:
receiving the access key from the authentication service; and
providing the access key to a media player to play content embedded on the content media.

10. The method of claim 8 further including instructions for:
receiving a denial from the authentication service; and
presenting a notification that content embedded on the content media cannot be played.

11. The method of claim 8 further instructions for:
receiving the access key from the authentication service; and
copying content embedded on the content media to memory or storage off of the content media in response to the access key.

12. The method of claim 8, wherein communicating further includes encrypting the identifier before communicating the identifier to the authentication service.

13. The method of claim 8, wherein acquiring includes at least one of:
receiving the identifier from a radio frequency identifier (RFI) reader, wherein the identifier is a RFI tag that uniquely identifies content embedded in the content media and the content media; and
receiving the identifier from a memory or storage of a machine, wherein the identifier is recorded in the memory or the storage from a chip that is activated by the machine when the content media is interfaced to the machine.

14. A method, including:
receiving a content identifier from a requestor that desires to play content embedded on content media, wherein the content identifier is embedded or affixed to the content media and is separate from the content residing on the media;
attempting to authenticate the content identifier in response to a policy associated with the content; and
communicating an access key to the requestor if the content identifier is authenticated successfully, otherwise communicating a denial notification to the requestor.

15. The method of claim 14, wherein receiving further includes decrypting the content identifier, which is received in an encrypted format.

16. The method of claim 14, wherein receiving further includes acquiring a geographic position for a machine of the requestor, and wherein the geographic position is evaluated in view of the policy to determine whether the content identifier is authenticated for the access key.

17. The method of claim 16, wherein acquiring further includes at least one of:
estimating the geographic position from an Internet Protocol (IP) address associated with the requestor; and
receiving the geographic position as a Global Positioning Satellite (GPS) coordinate from a device associated with the requestor.

18. The method of claim 14 further including, acquiring the policy from a licensing service, wherein the policy is associated with a license for the content and the policy is identified by the content identifier.

19. The method of claim 14 further including, alerting a reporting service if the content identifier is not authenticated.

20. The method of claim 14 further including:
receiving the content identifier from a second requestor or from the same requestor;
determining if the policy permits concurrent play of the content; and
communicating a different access key if the policy permits, otherwise denying the concurrent play.
